(19) United States
(12) Patent Application Publication
(10) Pub. No.: US 2015/0352712 A1
(43) Pub. Date: Dec. 10, 2015

(54) TRUCK BOX WALL CONNECTION

(71) Applicant: Craig Harrison, Gulf Breeze, FL (US)

(72) Inventor: Craig Harrison, Gulf Breeze, FL (US)

(21) Appl. No.: 14/299,472

(22) Filed: Jun. 9, 2014

(51) Int. Cl. B25H 5/00; B65D 6/00; B65D 6/02

(52) U.S. Cl. CPC B25H 5/00; B65D 7/06; B65D 11/10

(57) ABSTRACT

A truck box is provided having a wall connection construction that permits the box to be fabricated from one or more walls formed of aluminum tread plate or other metal connected to one or more other walls made of a material that may be molded to include a variety of accessory features and configurations.

### FIELD OF THE INVENTION

This invention relates to storage boxes for use with vehicles, and, more particularly, to a truck box having a wall connection construction that permits the box to be fabricated with walls formed of different materials.

### BACKGROUND OF THE INVENTION

One of the most popular accessories for trucks and recreational vehicles is a truck box used to store and secure a variety of tools and other items. There are a number of different types of truck boxes, including cross-over boxes, side mount boxes, chest boxes, top mount boxes, RV boxes and others. Truck boxes of this type comprise a front wall, a back wall, a bottom wall and opposed end walls which are interconnected to form a hollow interior. The truck box interior is closed by a top wall or lid pivotal between open and closed positions on a hinge mounted to the back wall, usually with the assistance of gas springs.

Typically, the walls of truck boxes are made of aluminum tread plate or a similar material which are connected by welding. Depending on the type of box, different accessories may be incorporated into the hollow interior to mount or store tools and other items. These accessories may include shelves, trays, pegs, hooks and other supports. Since the walls of the box are formed of aluminum or other metal, such accessories must be welded in place or supported on other structure that is welded to the box walls. Welding can be a time consuming and labor intensive part of the truck box construction which adds cost and weight to the overall product. Further, the type of accessory structures that may be welded to a metal box limits the variety and configuration of same.

### SUMMARY OF THE INVENTION

This invention is directed to a truck box having a wall connection construction that permits the box to be fabricated with one or more walls of materials that may be formed with a variety of accessory features and configurations not readily available in all-metal truck boxes.

In one presently preferred embodiment, a truck box is provided with a front wall, a rear wall, a bottom wall, opposed first and second end walls and a top wall. A first channel is formed along the opposed front and rear edges and the bottom edge of the first end wall, and a similar second channel is formed in the opposite second end wall. Both of the first and second channels preferably include a number of spaced, centering bosses. The front wall, rear wall and bottom wall may be formed in a unitary, one-piece assembly, such as by a bending operation, without welds. Opposite end portions of these three walls collectively define a first end connector and a second end connector, respectively, each having a number of bonding sites preferably in the form of spaced openings, recesses or projections.

In order to assemble the truck box of this embodiment, the first end connector formed by the end portions of the front, rear and bottom walls is inserted within the first channel in the first end wall and into engagement with the centering bosses. Similarly, the second end connector is inserted within the second channel in the second end wall where it engages the centering bosses therein. A bonding material such as adhesive, epoxy, urethane, silicone or the like is then poured or injected into the first and second channels such that it covers the first and second end connectors and either enters or surrounds the bonding sites therein to securely mount the end walls to the one-piece front, bottom and rear wall assembly.

In an alternative embodiment of a truck box according to this invention, the same type of joint connection is made between a wall assembly comprising the front, back and first and second end walls on the one hand, and the top and bottom walls on the other hand. Specifically, each of the top and bottom walls is formed with a channel having spaced centering bosses as in the embodiment described above. The top edge of each of the front, rear and first and second side walls collectively define a first end connector which may be inserted within the channel formed in the top wall. The bottom edge of the front, rear and first and second side walls collectively define a second end connector which may be inserted within the channel formed in the bottom wall. Both the first and second end connectors have bonding sites of the same type as in the embodiment discussed above, and the same bonding material may be used to connect the top and bottom walls to the wall assembly to form the truck box.

In each of the embodiments described above, a strong, durable connection is therefore provided between the walls of the truck box. Further, since no welding is required because the walls are joined by a bonding material, the ends walls in the first embodiment, and the top and bottom walls in the second embodiment, may be made of a different material than the other walls, e.g. plastic or composite material instead of aluminum tread plate or other metal. Plastic or composite material may be readily molded to form walls that include a variety of different accessory features such as self supports, trays, hooks, pegs and the like, which, in prior art boxes, either must be welded in place or could not be incorporated into the box at all.

### DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a perspective view of an assembled truck box incorporating one embodiment of the wall connection of this invention in which opposed end walls are joined to a one-piece assembly comprising the front, rear and bottom walls of the box;

FIG. 2 is an exploded, perspective view of the truck box illustrated in FIG. 1;

FIG. 3 is an enlarged elevational view of one of the end walls depicted in the box of FIGS. 1 and 2;

FIG. 4 is a view similar to FIG. 3 except schematically illustrating an end connector formed by the end portions of each of the front, rear and bottom wall assembly inserted within a channel formed in the end wall;

FIG. 5 is an exploded, perspective view of a truck box illustrating an alternative embodiment of the wall connection herein in which the front, rear and opposed end walls form an assembly which is connected to each of the top and bottom walls;

FIG. 6 is an enlarged, elevational view of the bottom of the top wall of the box shown in FIG. 5; and

FIG. 7 is an enlarged, elevational view of the top of the bottom wall of the box shown in FIG. 5.

### DETAILED DESCRIPTION OF THE INVENTION

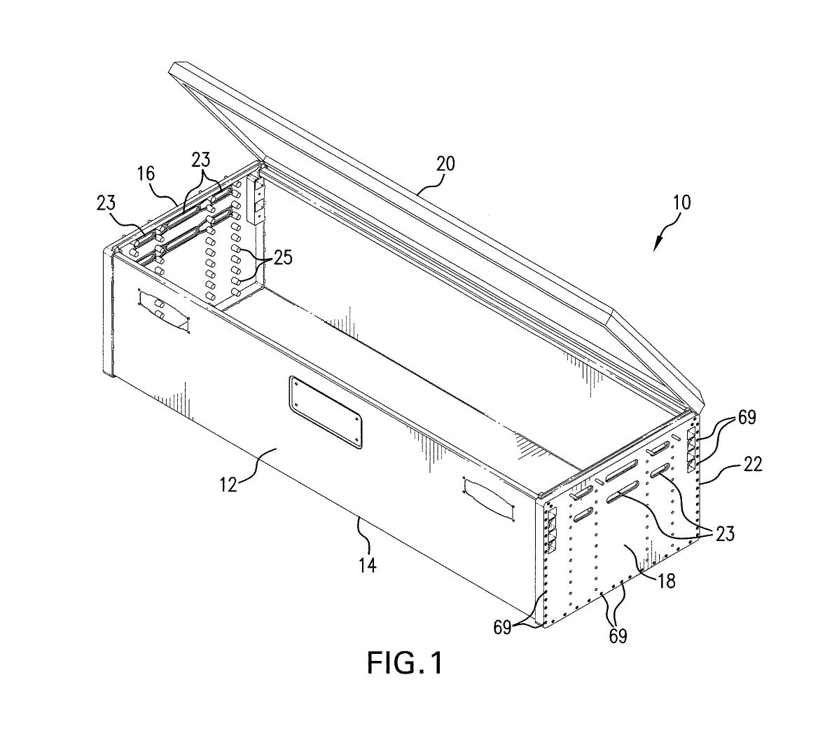

Referring initially to FIGS. 1-4, one embodiment of a truck box 10 is shown which comprises a front wall 12, a bottom wall 14, opposed end walls 16, 18, a lid or top wall 20 and a rear wall 22. Each end wall 16, 18 may be formed with openings 23 and include spaced pegs 25, which may be used for mounting shelves or other internal support structures (not shown). For purposes of illustration and the present discussion, a chest box is depicted in the Figs. but it is contemplated that other types of truck boxes may be fabricated with the wall connection construction of this invention, discussed below, including cross-over boxes, side-mount boxes, top mount boxes, trailer boxes, RV boxes and others. As used herein, the terms “front,” “rear,” “top,” “bottom,” “horizontal” and “vertical” refer to the orientation of the box 10 as depicted in FIG. 1.

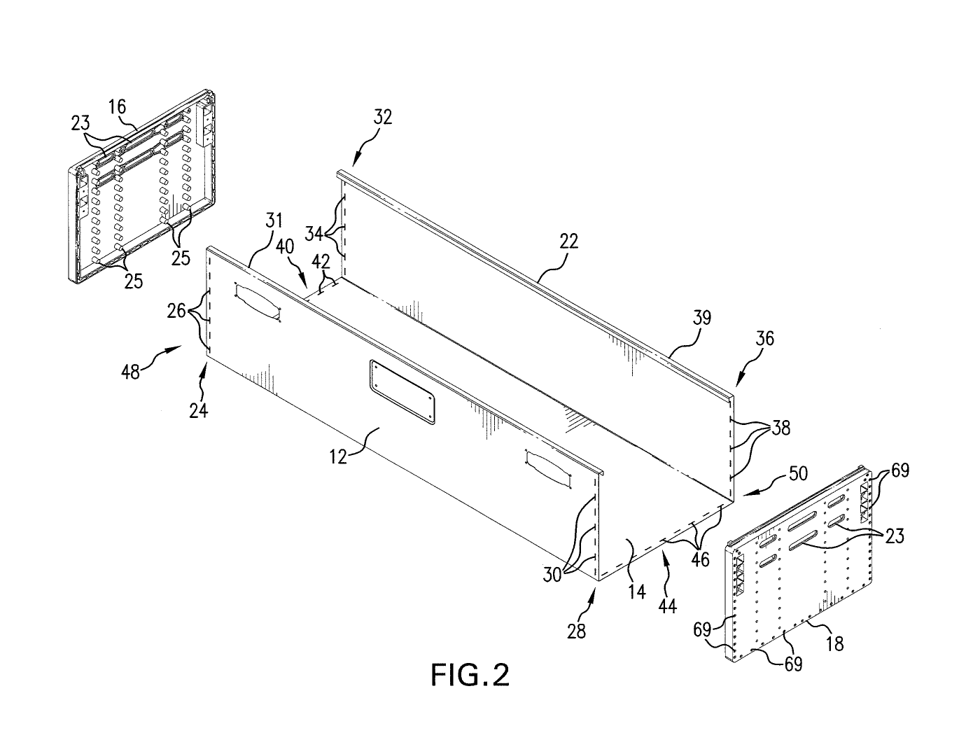

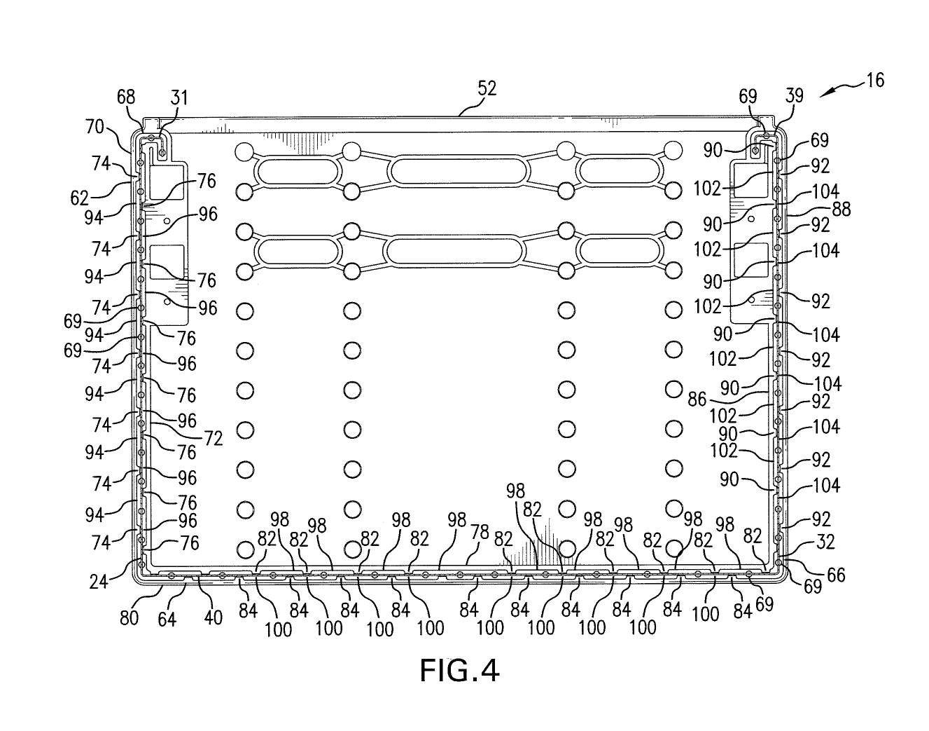

As best seen in FIG. 2, the front wall 12, bottom wall 14 and rear wall 22 of box 10 are preferably formed in a one-piece assembly, such as by a bending operation, with the front and rear walls 12, 22 generally perpendicular to the bottom wall 14. Each of the walls 12, 14 and 22 is preferably made of aluminum tread plate or other light-weight metal of the type commonly used in prior art truck boxes. One end of the front wall 12 is formed with an end portion 24 having a number of vertically spaced openings 26, and its opposite end has an end portion 28 with a number of vertically spaced openings 30. Preferably, the top edge 31 of the front wall 12 is formed in an inverted U-shape. See also FIG. 4. The rear wall 22 of box 10 has essentially the same construction as front wall 12. One end of the rear wall 22 has an end portion 32 formed with vertically spaced openings 34, and its opposite end is formed with an end portion 36 having vertically space openings 38. The top edge 39 of the rear wall 22 has the same inverted U-shape as the top edge 31 of the front wall 12. The bottom wall 14 of the box 10 has an end portion 40 with spaced openings 42 located in between the front and rear walls 12, 22, and an opposite end portion 44 with spaced openings 46 extending in the same direction as openings 42.

The end portions 24, 32 and 40 of front, rear and bottom walls 12, 22 and 14, respectively, collectively define a first end connector 48 having a plurality of bonding sites formed by the openings 26, 34 and 42 in such end portions 24, 32 and 40. Similarly, the opposite end portions 28, 36, and 44 of front, rear and bottom walls 12, 22 and 14 collectively define a second end connector 50 with bonding sites formed by openings 30, 38 and 46 in such end portions 28, 36 and 44.

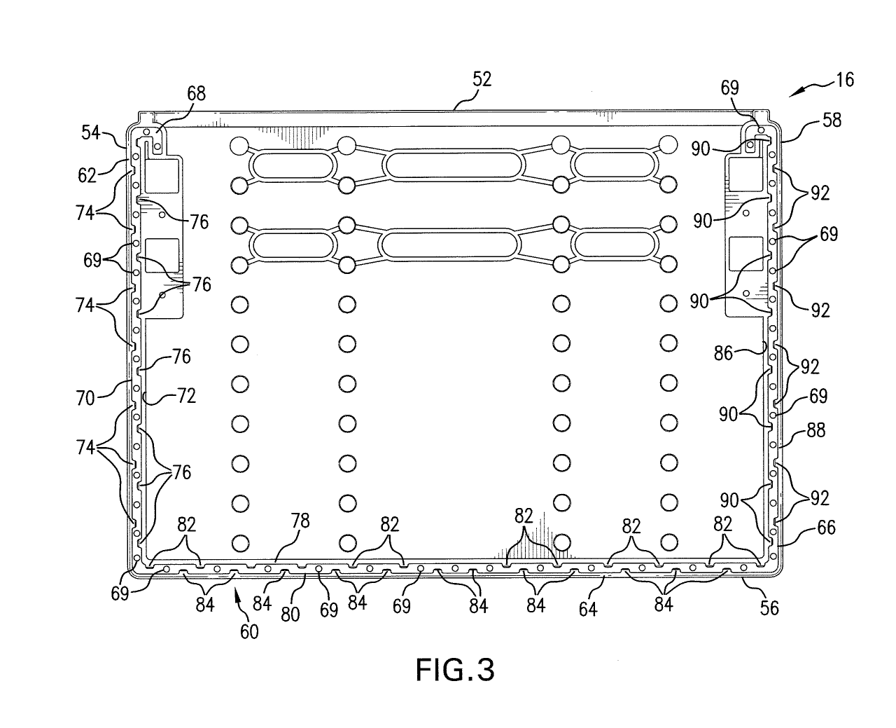

Referring now to FIG. 3, an enlarged view of the end wall 16 is illustrated, it being understood that the end wall 18 has the same construction and is not separately described herein. Each of the end walls 16, 18 is preferably formed of plastic, composite or other material which may be formed in a molding or casting operation. The end wall 16 has a top edge 52, a front edge 54, a bottom edge 56 and a rear edge 58. A channel 60 is formed along the front, bottom and rear edges 54-58 which is defined by a front leg 62 extending along the front edge 54 between the top and bottom edges 52, 56, a bottom leg 64 extending along the bottom edge 56 between the front and rear edges 54, 58, and, a rear leg 66 extending along the rear edge 58 between the top and bottom edges 52, 56. The front and rear legs 62, 66 of the channel 60 are formed with respective curved top ends 68 and 69 each in the general shape of an inverted “U.” Each of the front, bottom and rear legs 62, 64 and 66 of channel 60 is formed with a number of spaced holes 69 having a chamfer (not shown) at the outer surface of end wall 16.

The front leg 62 of channel 60 is defined by opposed side walls 70 and 72. The side wall 70 is formed with a number of vertically spaced bosses 74 each extending in a direction toward the opposite side wall 72. Similarly, the side wall 72 is formed with a number of vertically spaced bosses 76 which are offset from the bosses 74 in the vertical direction and extend toward the side wall 70. The bottom leg 64 and rear leg 66 of channel 60 have a similar construction as that of front leg 62. Specifically, the bottom leg 64 of channel 60 is defined by opposed side walls 78 and 80. The side wall 78 is formed with a number of horizontally spaced bosses 82 each extending in a direction toward the opposite side wall 80, and the side wall 80 is formed with a number of horizontally spaced bosses 84 which are offset from the bosses 82 in the horizontal direction and extend toward the side wall 78. The rear leg 66 of channel 60 is defined by opposed side walls 86 and 88. The side wall 86 is formed with a number of vertically spaced bosses 90 each extending in a direction toward the opposite side wall 88. Similarly, the side wall 88 is formed with a number of vertically spaced bosses 92 which are offset from the bosses 90 in the vertical direction and extend toward the side wall 86.

The front, bottom and rear walls 12, 14 and 22, and the end walls 16, 18, are assembled as schematically depicted in FIG. 4 by inserting the first end connector 48 into the channel 60 of end wall 16 and the second end connector 50 into the channel (not shown) of the end wall 18. With specific reference to end wall 16 illustrated in FIG. 4, the end portion 24 of the front wall 12 is inserted into the front leg 62 of channel 60 such that it is captured and aligned between the staggered bosses 74, 76 along respective side walls 70, 72 of such front leg 62, and its curved top edge 31 extends into the curved top end 68 of the front leg 62 of channel 60. A number of vertically spaced cavities 94 are defined along the front leg 62 of channel 60, each located in one of the spaces formed between the side wall 70, the end portion 24 of front wall 12 and two adjacent bosses 74. Additionally, vertically spaced cavities 96 are formed along the opposite side of the end portion 24 of front wall 12 within front leg 62 of channel 60, each defined by the side wall 72, the end portion 24 and two adjacent bosses 76.

The other two components of the first end connector 48, e.g. the end portion 40 of bottom wall 14 and end portion 32 of rear wall 22, are inserted into the bottom leg 64 and rear leg 66 of channel 60, respectively, and captured by the bosses 82, 84 and bosses 90, 92 therein in the same manner as described above. Additionally, the curved top edge 39 of the end portion 32 of rear wall 22 extends into the curved top end 69 of the rear leg 66 of channel 60. As a result, a number of horizontally spaced cavities 98 are defined along the bottom leg 64 of channel 60, each located in one of the spaces formed between the side wall 78 of bottom leg 64, the end portion 40 of bottom wall 14 and two adjacent bosses 82. Vertically spaced cavities 100 are also formed along the opposite side of the end portion 40 within bottom leg 64 of channel 60, each defined by the side wall 80, the end portion 40 and two adjacent bosses 84. Similarly, a number of vertically spaced cavities 102 are defined along the rear leg 66 of channel 60, each located in one of the spaces formed between the side wall 86 of rear leg 66, the end portion 32 of rear wall 22 and two adjacent bosses 90. Additionally, vertically spaced cavities 104 are formed along the opposite side of the end portion 32 of rear wall 22 within rear leg 66 of channel 60, each defined by the side wall 88, the end portion 32 and two adjacent bosses 92.

As noted above, the end wall 18 has the same construction as end wall 16 and is joined to the second connector 50 formed by the front, bottom and rear walls 12, 14, 22 in the same manner described above. With the end walls 16, 18 in the position shown in FIG. 4, a bonding material such as adhesive, epoxy, urethane, silicone or similar material may be poured into the channels 60 such that it fills all of the cavities 94-104 and enters the bonding sites of the end connectors 48 and 50, i.e. the openings 26, 32 and 42 formed in respective end portions 24, 32 and 40 on one end of the front, rear and bottom walls 12, 22 and 14, and, the openings 30, 38 and 46 formed in end portions 28, 36 and 44, respectively, on the opposite end of front, rear and bottom walls 12, 22 and 14. Additionally, the bonding material enters each of the holes 69 formed in the end walls 16, 18 along the channels 60. Once the bonding material has cured, a strong connection is made between the end walls 16, 18, and the front, rear and bottom walls 12, 22 and 14.

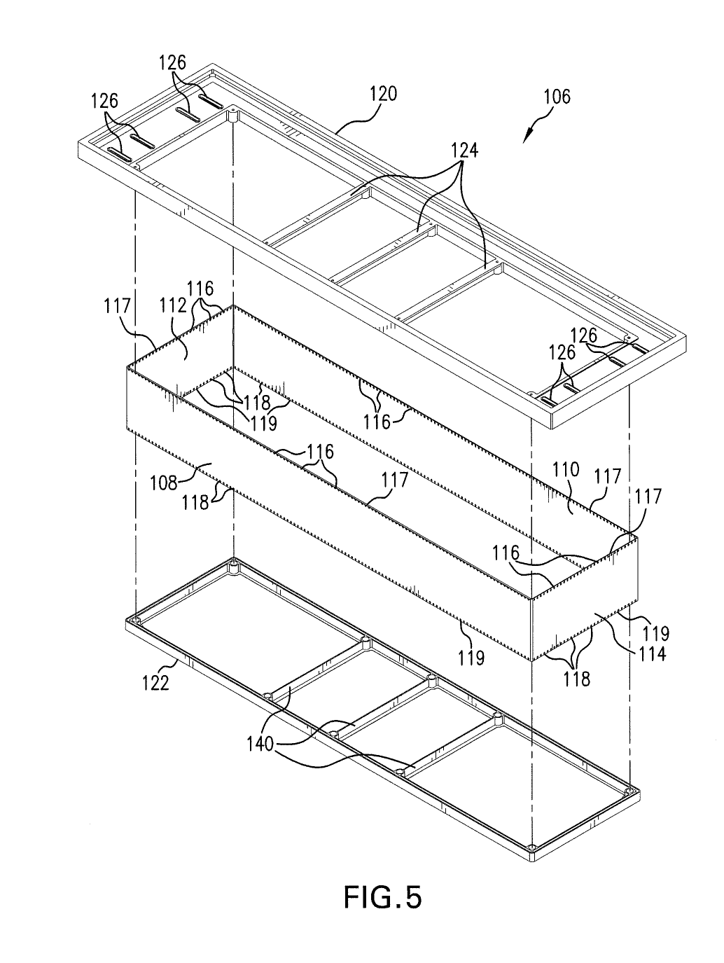

Referring now to FIGS. 5-7, an alternative embodiment of a truck box 106 according to this invention is schematically illustrated in an exploded, perspective view. The box 106 of this embodiment includes a front wall 108, a rear wall 110 and opposed end walls 112, 114 which are connected to one another and preferably formed of aluminum tread plate or similar light-weight metal. It is contemplated that three of the four walls 108-114 may be formed in a one-piece construction, such as by a bending operation, and then one of them welded to the fourth wall to form the unitary structure shown in FIG. 5. Each of the walls 108-114 includes horizontally spaced openings 116 along a top edge 117 thereof, and horizontally spaced openings 118 along their bottom edges 119.

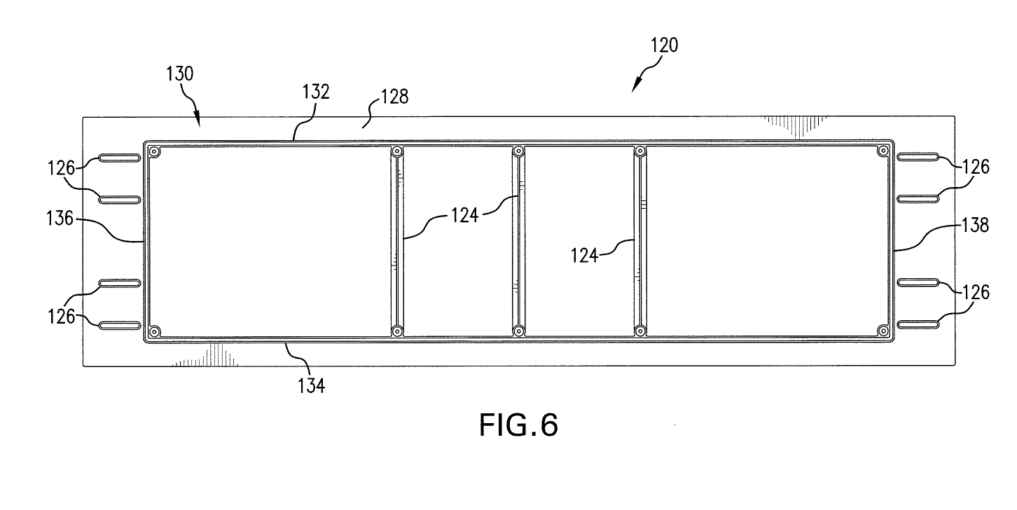

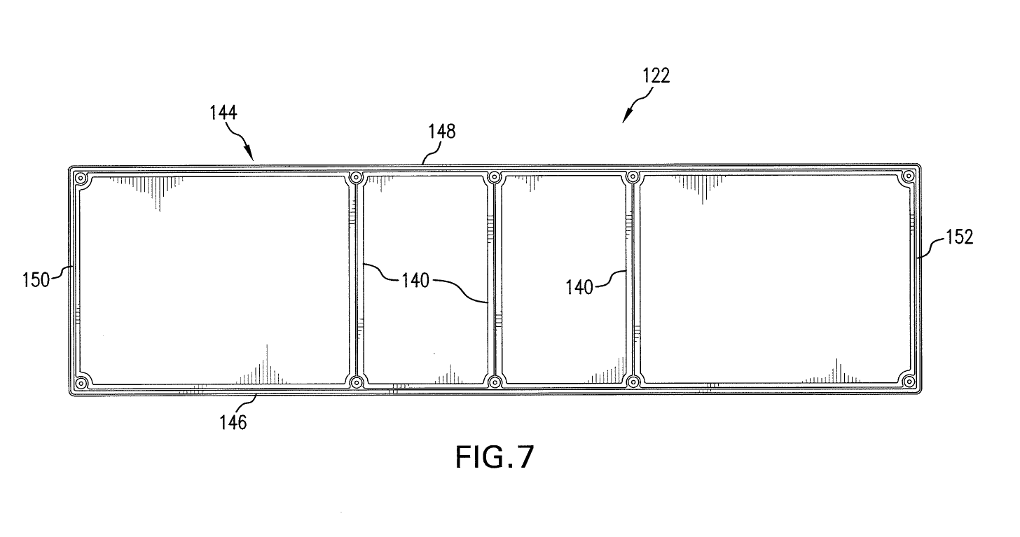

The truck box 106 further includes a lid or top wall 120 and a bottom wall 122 which are preferably formed of a plastic, composite or other material which may be formed in a molding or casting operation. The top wall 120 is schematically shown with cross braces 124 and slots 126 at opposite ends, but such structural details can be altered, as desired. The key feature of top wall 120 for purposes of the present discussion is its bottom surface 128 formed with a channel 130 having front and rear portions 132, 134 and opposed end portions 136, 138. See FIG. 6. The channel 130 has the same arrangement of bosses described above in connection with channel 60, and it receives the top edge 117 of each of the front, rear and end walls 108-114 forming cavities (not shown) as in the embodiment of FIGS. 1-4. The bottom wall 122 is schematically shown in FIGS. 5 and 7 with cross braces 140 and a channel 144 having opposed front and rear portions 146, 148 and opposed end portions 150, 152. Channel 144 includes bosses (not shown), as in channel 60, which center the bottom edge 119 of each of the front, rear and end walls 108-114 of the box 106 within the channel 144 forming cavities (not shown) as described above in connection with a discussion of the embodiment of FIGS. 1-4.

After the front, rear and end walls 108-114 are in place within respective channels 130, 144 in top and bottom walls 120, 122, a bonding material of the type described above may be poured into such channels 130, 144 where it flows into and adheres to the bonding sites or openings 116 and 118 formed along respective top and bottom edges 117, 119 of each of such walls 108-114. Upon curing, the bonding material creates a secure connection between the top and bottom walls 120, 122 on the one hand, and the front, rear and end walls 108-114 on the other hand.

An important feature of the present invention is that the means of connecting the walls together allows for the use of plastic, composite or other materials which are capable of being molded or cast to form selected walls of the truck boxes 10 or 106 instead of aluminum tread plate as in prior art box designs. As a result, many more features such as shelf supports, trays, brackets, hooks and the like may be incorporated into the walls made of plastic or composite, such as by a molding operation, thus eliminating a number of difficult, time consuming and expensive welds which were required in prior art boxes.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof.

For example, the bonding sites employed in the embodiment of FIGS. 1-4, and in the embodiment of FIGS. 5-7, are described above as openings in the end portions or edges of the walls which enter the channels 60, 130 or 144, e.g. slots, holes or the like which extend entirely through such walls. It is contemplated that such bonding sites could be formed by recesses, or by projections or other structures that extend outwardly from the end portions or edges of the walls, such that the bonding material can flow around and adhere to same in order to form a secure bond between the adjoining walls.

Therefore, it is intended that the invention not be limited to the particular embodiment disclosed as the best mode contemplated for carrying out this invention, but that the invention will include all embodiments falling within the scope of the appended claims.

What is claimed is:

1. A truck box, comprising:
a front wall, a rear wall, a bottom wall and first and second end walls;
each of said first and second end walls having a top edge, a bottom edge, a front edge and a rear edge;
a first channel formed along said front, bottom and rear edges of said first end wall, said first channel having opposed side walls each formed with a number of spaced first centering bosses;
a second channel formed along said front, bottom and rear edges of said second end wall, said second channel having opposed side walls each formed with a number of spaced second centering bosses;
said front wall, rear wall and bottom wall collectively forming a first end connector and an opposed second end connector, said first and second end connectors each being formed with a number of bonding sites, said first end connector being inserted within said first channel in said first end wall in engagement with said spaced first centering bosses, a bonding material being introduced into said first channel which adheres to said bonding sites of said first end connector, said second end connector being inserted into said second channel in said second end wall in engagement with said spaced second centering bosses, said bonding material being introduced into said second channel which adheres to said bonding sites of said second end connector.

2. The truck box of claim 1 in which said first centering bosses formed on each one of said side walls in said first channel each extend in a direction toward the opposite side wall thereof, and said second centering bosses formed on each one of said side walls in said second channel each extend in a direction toward the opposite side wall thereof.

3. The truck box of claim 2 in which said centering bosses on one side wall of each of said first and second channels are offset from said centering bosses on the other side wall thereof.

4. The truck box of claim 2 in which said first end connector is captured between said first centering bosses on said opposed side walls of said first channel, and said second end connector is captured between said second centering bosses on said opposed side walls of said second channel.

5. The truck box of claim 4 in which a number of first cavities are formed in said first channel each defined by a space between one side wall of said first channel, a portion of said first end connector and two adjacent first centering bosses, a number of second cavities being formed in said first channel each defined by a space between the other side wall of said first channel, a portion of said first end connector and two adjacent first centering bosses, said bonding material entering said first and second cavities in contact with said bonding sites of said first end connector.

6. The truck box of claim 4 in which a number of third cavities are formed in said second channel each defined by a space between one side wall of said second channel, a portion of said second end connector and two adjacent second centering bosses, a number of fourth cavities being formed in said second channel each defined by a space between the other side wall of said second channel, a portion of said second end connector and two adjacent centering bosses, said bonding material entering said third and fourth cavities in contact with said bonding sites of said second end connector.

7. The truck box of claim 1 in which said first end connector comprises one end portion of each of said front wall, rear wall and bottom wall, and said second end connector comprises an opposite end portion of each of said front wall, rear wall and bottom wall.

8. The truck box of claim 7 in which said bonding sites comprises a number of openings formed in said one end portion of said front wall, rear wall and bottom wall, and a number of openings formed in said opposite end portion of said front wall, rear wall and bottom wall.

9. The truck box of claim 1 in which said front wall, rear wall and bottom wall are formed in a one-piece assembly.

10. The truck box of claim 1 in which said first and second end walls are formed of a first material, said front wall, rear wall and bottom wall being formed of a second material which is different than said first material.

11. The truck box of claim 10 in which said first material is plastic.

12. The truck box of claim 10 in which said first material is composite.

13. The truck box of claim 10 in which said second material is aluminum tread plate.

14. The truck box of claim 1 in which each of said first and second end walls is formed with a number of holes spaced along respective first and second channels, said bonding material introduced into said first and second channels flowing into said spaced holes and adhering thereto.

15. A truck box, comprising:
a front wall, a rear wall, a top wall, a bottom wall and opposed end walls;
a first channel formed in said top wall, said first channel having opposed side walls each formed with a number of spaced first centering bosses;
a second channel formed in said bottom wall, said second channel having opposed side walls each formed with a number of spaced second centering bosses;
said front wall, rear wall and opposed end walls each having a top edge portion which collectively define a first end connector, said front wall, rear wall and opposed end walls each having a bottom edge portion which collectively define a second end connector, said first and second end connectors each being formed with a number of bonding sites, said first end connector being inserted within said first channel in said top wall in engagement with said spaced first centering bosses, a bonding material being introduced into said first channel which adheres to said bonding sites of said first end connector, said second end connector being inserted within said second channel in said bottom wall in engagement with said spaced second centering bosses, said bonding material being introduced into said second channel which adheres to said bonding sites of said second end connector.

16. The truck box of claim 15 in which said first centering bosses on each one of said side walls in said first channel each extend in a direction toward the opposite side wall thereof, and said second centering bosses formed on each one of said side walls in said second channel each extend in a direction toward the opposite side wall thereof.

17. The truck box of claim 16 in which said first centering bosses on one side wall of said first channel are offset from said centering bosses on the other side wall thereof, and said second centering bosses formed on one of said side walls in said second channel are offset from said centering bosses on the other side wall thereof.

18. The truck box of claim 17 in which a number of first cavities are formed in said first channel each defined by a space between one side wall of said first channel, a portion of said first end connector and two adjacent first centering bosses, a number of second cavities being formed in said first channel each defined by a space between the other side wall of said first channel, a portion of said first end connector and two adjacent first centering bosses, said bonding material entering said first and second cavities in contact with said bonding sites of said first end connector.

19. The truck box of claim 18 in which a number of third cavities are formed in said second channel each defined by a space between one side wall of said second channel, a portion of said second end connector and two adjacent second centering bosses, a number of fourth cavities being formed in said second channel each defined by a space between the other side wall of said second channel, a portion of said second end connector and two adjacent centering bosses, said bonding material entering said third and fourth cavities in contact with said bonding sites of said second end connector.

20. The tool box of claim 14 in which said bonding sites comprise a number of openings formed in said top edge portion of each of said front wall, rear wall and opposed end walls, and a number of openings formed in said bottom edge portion of each of said front wall, rear wall and opposed end walls.

21. The tool box of claim 14 in which said front wall, rear wall, bottom wall and opposed end walls are formed of a first material, said top wall and said bottom wall being formed of a second material which is different from said first material.

22. The tool box of claim 21 in which said second material is plastic or composite.

23. The tool box of claim 21 in which said first material is aluminum tread plate.
